(19) United States
(12) Patent Application Publication
(10) Pub. No.: US 2025/0029159 A1
(43) Pub. Date: Jan. 23, 2025

(54) MOBILE OBJECT BROKERAGE SYSTEM AND MOBILE OBJECT BROKERAGE METHOD

(71) Applicant: HONDA MOTOR CO., LTD., Tokyo (JP)

(72) Inventors: Hodaka Tsuge, Tokyo (JP); Hiroshi Ishikawa, Tokyo (JP); Naotaka Morita, Tokyo (JP)

(21) Appl. No.: 18/754,236

(22) Filed: Jun. 26, 2024

(30) Foreign Application Priority Data
Jul. 21, 2023 (JP) 2023-119195

(51) Int. Cl. G06Q 30/0601

(52) U.S. Cl. CPC G06Q 30/0619

(57) ABSTRACT

A mobile object brokerage system includes a desired-remaining-life condition recognition section configured to recognize a desired-remaining-life condition of a user for a mobile object, a candidate-mobile-object remaining-life recognition section, a remaining-life consumption degree recognition section configured to recognize a remaining-life consumption degree on the basis of use history information about a mobile object by the user, a corrected-remaining-life calculation section configured to calculate a corrected remaining life obtained by correcting the remaining life of each of the plurality of candidate mobile objects with the remaining-life consumption degree, and a transaction target mobile-object selection section configured to select, as a target for a predetermined transaction with the user U, the candidate mobile object having the corrected remaining life that meets the desired-remaining-life condition.

### INCORPORATION BY REFERENCE

The present application claims priority under 35 U.S.C. § 119 to Japanese Patent Application No. 2023-119195 filed on Jul. 21, 2023. The content of the application is incorporated herein by reference in its entirety.

### BACKGROUND OF THE INVENTION

### Field of the Invention

The present invention relates to a mobile object brokerage system and a mobile object brokerage method.

### Description of the Related Art

A sale and purchase brokerage system has been conventionally proposed that matches a prospective seller who wishes to sell merchandise with a prospective buyer who wishes to buy the merchandise on the basis of merchandise information inputted by the prospective seller and purchase request information inputted by the prospective buyer (see, for example, Japanese Patent Laid-Open No. 2005-115434).

In addition, a configuration has been proposed in which, in a used-car system that mediates between an exhibitor of a vehicle and a prospective buyer of the vehicle, a result of an evaluation of vehicle information made by a third party that does a maintenance service for the vehicle is provided to the prospective buyer of the vehicle to allow the prospective buyer to objectively confirm the accuracy and the authenticity of the vehicle information (see, for example, Japanese Patent Laid-Open No. 2021-149320).

The life of a vehicle depends on the usage of the vehicle by a user and a vehicle used under a heavy load tends to have a shorter life. Thus, depending on the usage of a vehicle before purchase or the usage of the vehicle after purchase, the actual life of the vehicle is sometimes shorter than the life expected by a user. The Related Art does not, however, determine the remaining life of a vehicle to be bought. The life of the vehicle may therefore expire before the usable period expected at the time of purchase by a user who bought the vehicle.

This application has been filed in view of such background and has an object of providing a mobile object brokerage system and a mobile object brokerage method that each make it possible to match a user who intends to start the use of a mobile object such as a vehicle through a transaction with a mobile object which meets a desired-remaining-life condition of the user.

### SUMMARY OF THE INVENTION

A first aspect for achieving the object includes a mobile object brokerage system including: a desired-remaining-life condition recognition section; a candidate-mobile-object remaining-life recognition section; a remaining-life consumption degree recognition section; a corrected-remaining-life calculation section; and a transaction target mobile-object selection section. The desired-remaining-life condition recognition section is configured to recognize a desired-remaining-life condition of a user for a mobile object. The user intends to start use of a mobile object through a predetermined transaction. The candidate-mobile-object remaining-life recognition section is configured to recognize a remaining life of each of a plurality of candidate mobile objects that are candidates in the predetermined transaction. The remaining-life consumption degree recognition section is configured to recognize a remaining-life consumption degree on the basis of use history information about a mobile object by the user. The remaining-life consumption degree is a consumption degree of a remaining life of a mobile object per predetermined period for the user to use the mobile object. The corrected-remaining-life calculation section is configured to calculate a corrected remaining life obtained by correcting the remaining life of each of a plurality of the candidate mobile objects recognized by the candidate-mobile-object remaining-life recognition section with the remaining-life consumption degree. The transaction target mobile-object selection section is configured to select, as a target for the predetermined transaction with the user, the candidate mobile object having the corrected remaining life that meets the desired-remaining-life condition.

The mobile object brokerage system may include a mobile-object usage change estimation section configured to estimate a change in usage of a mobile object by the user. The change is to be made after the user starts the use of the mobile object in the predetermined transaction. The remaining-life consumption degree recognition section may be configured to recognize the remaining-life consumption degree by correcting the consumption degree of the remaining life of the mobile object per predetermined period for the user to use the mobile object in accordance with the change in the usage of the mobile object by the user. The consumption degree is based on the use history information. The change is estimated by the mobile-object usage change estimation section.

In the mobile object brokerage system, the mobile-object usage change estimation section may be configured to estimate the change in the usage of the mobile object by the user on the basis of profile information about the user or schedule information about the user. The change is to be made after the user starts the use of the mobile object in the predetermined transaction.

In the mobile object brokerage system, the transaction target mobile-object selection section may be configured to select, as the candidate mobile object having the corrected remaining life that meets the desired-remaining-life condition, the candidate mobile object having a difference of a predetermined value or less between the corrected remaining life and a desired life corresponding to the desired-remaining-life condition.

In the mobile object brokerage system, the candidate-mobile-object remaining-life recognition section may be configured to recognize a remaining life for each of a plurality of target parts included in the candidate mobile object. The remaining-life consumption degree recognition section may be configured to recognize the remaining-life consumption degree for each of a plurality of the target parts. The corrected-remaining-life calculation section may be configured to calculate the corrected remaining life for each of a plurality of the target parts. The transaction target mobile-object selection section may be configured to determine for each of a plurality of the target parts whether or not the corrected remaining life meets the desired-remaining-life condition, and select the candidate mobile object that meets the desired-remaining-life condition.

A second aspect for achieving the object includes a mobile object brokerage method that is executed by a computer to mediate between a user who wishes to use a mobile object and a provider of the mobile object. The mobile object brokerage method includes: a desired-remaining-life condition recognition step; a candidate-mobile-object remaining-life recognition step; a remaining-life consumption degree recognition step; a corrected-remaining-life calculation step; and a transaction target mobile-object selection step. In the desired-remaining-life condition recognition step, a desired-remaining-life condition of a user for a mobile object is recognized. The user intends to start use of a mobile object through a predetermined transaction. In the candidate-mobile-object remaining-life recognition step, a remaining life of each of a plurality of candidate mobile objects that are candidates in the predetermined transaction is recognized. In the remaining-life consumption degree recognition step, a remaining-life consumption degree is recognized on the basis of use history information about a mobile object by the user. The remaining-life consumption degree is a consumption degree of a remaining life of a mobile object per predetermined period for the user to use the mobile object. In the corrected-remaining-life calculation step, a corrected remaining life obtained by correcting the remaining life of each of a plurality of the candidate mobile objects recognized by the candidate-mobile-object remaining-life recognition step with the remaining-life consumption degree is calculated. In the transaction target mobile-object selection step, the candidate mobile object having the corrected remaining life that meets the desired-remaining-life condition is selected as a target for the predetermined transaction with the user.

### Advantageous Effects of Invention

The mobile object brokerage system and the mobile object brokerage method each make it possible to match a user who intends to start the use of a mobile object such as a vehicle through a transaction with a mobile object which meets a desired-remaining-life condition of the user.

### BRIEF DESCRIPTION OF THE DRAWINGS

FIG. 1 is an explanatory diagram of a configuration of a mobile object brokerage system;

FIG. 2 is an explanatory diagram of a load and a physical property value that are measured for a target part;

FIG. 3 is an explanatory diagram of information that is recorded in a vehicle management database;

FIG. 4 is an explanatory diagram of a process of calculating a remaining life of a vehicle;

FIG. 5 is an explanatory diagram of a process of calculating a corrected remaining life of a candidate vehicle;

FIG. 6 is a flowchart of a process of calculating a corrected remaining life of the target part;

FIG. 7 is a flowchart of a process of selecting a transaction target vehicle;

FIG. 8 is an explanatory diagram of a process of setting the process of calculating the corrected remaining life of the candidate vehicle in accordance with a remaining-life consumption degree of each user; and

FIG. 9 is an explanatory diagram of a process of calculating the corrected remaining life of the candidate vehicle based on a corrected remaining-life consumption degree.

### DETAILED DESCRIPTION OF THE PREFERRED EMBODIMENTS

### 1. Configuration of Mobile Object Brokerage System

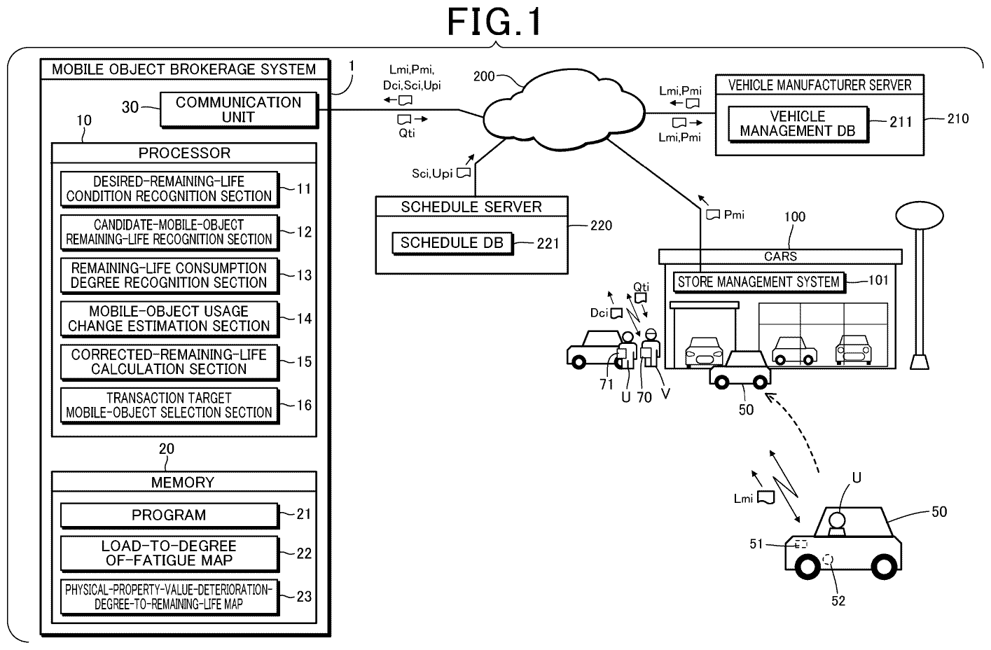

A configuration of a mobile object brokerage system 1 according to the present embodiment will be described with reference to FIGS. 1 to 5. The mobile object brokerage system 1 performs a process of matching a vehicle (corresponding to a mobile object according to the present disclosure) to be provided by a car dealer 100 through a predetermined transaction with a user who wishes to use the vehicle. The predetermined transaction includes the sale of a new car, the sale of a used car, and a vehicle lease contract. In the present embodiment, a case will be described where the mobile object brokerage system 1 matches a used vehicle with a user.

FIG. 1 exemplifies a case where a user U who wishes to buy a used vehicle sells a vehicle 50 that the user U used to use and selects a vehicle to be bought. In the present embodiment, the vehicle 50 and a candidate vehicle for a selection target of the user U are vehicles of the same manufacturer, are handled by the car dealer 100, and their usages are managed by a vehicle manufacturer server 210 that is a management server of the vehicle manufacturer which manufactured them.

The vehicle manufacturer server 210 communicates with a plurality of management target vehicles including the vehicle 50 and a store management system 101 of the car dealer 100 through a communication network 200. The vehicle 50 includes sensors 52 that each detect a load applied to a target part of the vehicle 50 and an electronic control unit (ECU) 51, and the ECU 51 transmits, to the vehicle manufacturer server 210, load measurement information Lmi indicating a result of the detection of the load detected by each of the sensors 52, for example, when the vehicle 50 is powered on. The same applies to the other management target vehicles.

When a management target vehicle is brought to the car dealer 100 for maintenance such as a periodic inspection, the service staff measures a physical property value of a target part of the management target vehicle with a measuring device. The store management system 101 then transmits, to the vehicle manufacturer server 210, physical property value measurement information Pmi indicating a result of the measurement of the physical property value.

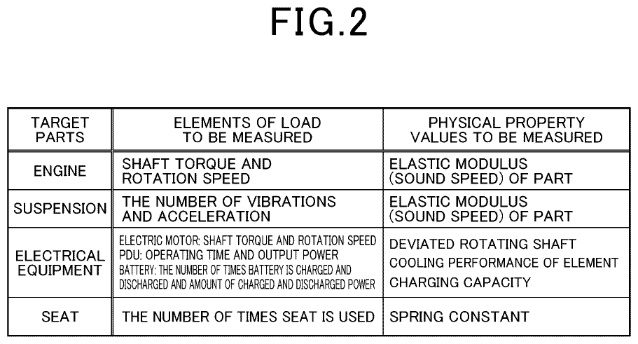

In the present embodiment, an engine, a suspension, electrical equipment, and a seat are set as target parts whose loads and physical property values are measured as illustrated in FIG. 2. For the engine, shaft torque and rotation speed are measured as elements of the load and the elastic modulus (sound speed) of the part is measured as the physical property value. For the suspension, the number of vibrations and acceleration are measured as elements of the load and the elastic modulus (sound speed) of the part is measured as the physical property value. For the electrical equipment, the shaft torque and the rotation speed of an electric motor, the operating time and the output power of a power drive unit (PDU), and the number of times a battery is charged and discharged and the amount of charged and discharged power are measured as elements of the load. In addition, the deviated rotating shaft of the electric motor, the cooling performance of an element of the PDU, and the charging capacity of the battery are measured as the physical property values. For the seat, the number of times the seat is used is measured as an element of the load and the spring constant is measured as the physical property value. The load measurement information Lmi and the physical property value measurement information Pmi regarding each target part of each management target vehicle are transmitted to the vehicle manufacturer server 210.

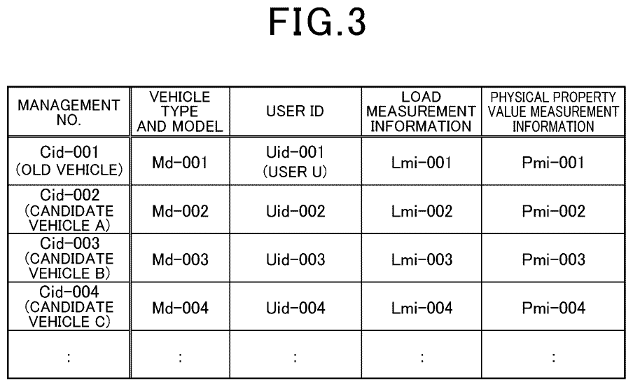

The vehicle manufacturer server 210 receives the load measurement information Lmi transmitted from each management target vehicle and the physical property value measurement information Pmi transmitted from the store management system 101, and records them in a vehicle management database (DB) 211 for each management target vehicle. FIG. 3 illustrates pieces of recorded data in the vehicle management DB 211 that correspond to the vehicle 50 (management No.: Cid-001 that will also be referred to as old vehicle 50 below) used by the user U, and a candidate vehicle A (management No.: Cid-002), a candidate vehicle B (management No.: Cid-003), and a candidate vehicle C (management No.: Cid-004) that are candidates to be matched with the user U.

The mobile object brokerage system 1 is a computer system including a processor 10, a memory 20, and a communication unit 30. The mobile object brokerage system 1 communicates with the vehicle manufacturer server 210, a schedule server 220, a staff terminal 70 that is used by service staff V of the car dealer 100, a user terminal 71 that is used by the user U, and the like through the communication network 200 by using the communication unit 30. The staff terminal 70 and the user terminal 71 are a tablet terminal, a personal computer, a smartphone, and the like.

A schedule application for managing the schedule of the user U is installed in the user terminal 71. Schedule information Sci about the user U and profile information Upi about the user U inputted by the user U through the schedule application are transmitted from the user terminal 71 to the schedule server 220 and recorded in a schedule DB 221 of the schedule server 220. The profile information Upi includes the sex, the age, the place of residence, the occupation, and the family structure of the user U. The schedule information Sci includes the scheduled period in which the next event (such as marriage, child birth, a change of address, retiring age, or child growth and independence) of the user U is going to occur.

A program 21 for control over the mobile object brokerage system 1, a map (load-to-degree-of-fatigue map) 22 for converting a detection value of a load indicated by the load measurement information Lmi about a target part to a weight for the degree of fatigue of the target part, and a map (physical-property-value-deterioration-degree-to-remaining-life map) 23 for converting a measurement value of a physical property value indicated by the physical property value measurement information Pmi about the target part to the estimated remaining life of the target part are saved in the memory 20.

The processor 10 reads and executes the program 21 to function as a desired-remaining-life condition recognition section 11, a candidate-mobile-object remaining-life recognition section 12, a remaining-life consumption degree recognition section 13, a mobile-object usage change estimation section 14, a corrected-remaining-life calculation section 15, and a transaction target mobile-object selection section 16. A process that is executed by the desired-remaining-life condition recognition section 11 corresponds to a desired-remaining-life condition recognition step in a mobile object brokerage method according to the present disclosure and a process that is executed by the candidate-mobile-object remaining-life recognition section 12 corresponds to a candidate-mobile-object remaining-life recognition step according to the present disclosure. A process that is executed by the remaining-life consumption degree recognition section 13 corresponds to a remaining-life consumption degree recognition step in the mobile object brokerage method according to the present disclosure and a process that is executed by the corrected-remaining-life calculation section 15 corresponds to a corrected-remaining-life calculation step according to the present disclosure. A process that is executed by the transaction target mobile-object selection section 16 corresponds to a transaction target mobile-object selection step according to the present disclosure.

The desired-remaining-life condition recognition section 11 receives desired-remaining-life condition information Dci transmitted from the staff terminal 70 and recognizes desired-remaining-life conditions (the remaining life period and the remaining life distance) for a vehicle to be bought by the user U that are indicated by the desired-remaining-life condition information Dci. The user U lets the service staff V know the desired-remaining-life conditions of the user U when the user U visits the car dealer 100, and the desired-remaining-life conditions are inputted to the staff terminal 70. Alternatively, the desired-remaining-life condition information Dci may be transmitted from the user terminal 71 to the mobile object brokerage system 1 by the user U inputting a desired remaining life with a vehicle purchase support application installed in the user terminal 71.

The candidate-mobile-object remaining-life recognition section 12 recognizes the remaining lives of candidate vehicles (candidate vehicles A to C below) to be matched with the user U. The candidate-mobile-object remaining-life recognition section 12 recognizes the remaining lives of the target parts (the engines, the suspensions, the pieces of electrical equipment, and the seats) of the candidate vehicles A to C. The candidate-mobile-object remaining-life recognition section 12 recognizes the remaining lives of the respective target parts by using, for example, the technique described in Japanese Patent Application No. 2022-172125, which is a patent application previously filed by the applicant of this application, on the basis of the pieces of load measurement information Lmi and the pieces of physical property value measurement information Pmi about the respective target parts of the candidate vehicles A to C that are recorded in the vehicle management DB 211.

The candidate-mobile-object remaining-life recognition section 12 applies a load recognized from the load measurement information Lmi about a target part to the load-to-degree-of-fatigue map 22 to obtain the corresponding weight, adds up the weighted number of times each load level is measured to calculate the degree of accumulated fatigue, and subtracts the degree of accumulated fatigue from 100% to calculate a first estimated remaining life. In addition, the candidate-mobile-object remaining-life recognition section 12 applies a physical property value deterioration degree recognized from the physical property value measurement information Pmi to the physical-property-value-deterioration-degree-to-remaining-life map 23 to recognize a second estimated remaining life of a target part.

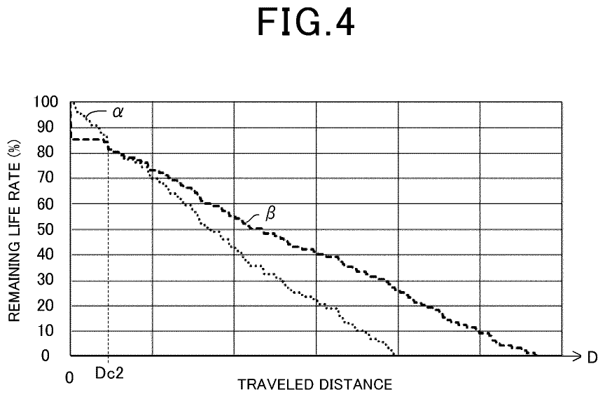

FIG. 4 exemplifies a first estimated remaining life α based on the load measurement information Lmi and a second estimated remaining life β based on the physical property value measurement information Pmi by setting the longitudinal axis as the remaining life rate (the rate of the remaining life with the life set to 100%) for a target part of any of the candidate vehicles A to C and setting the transverse axis as the traveling-guaranteed distance of a candidate mobile object corresponding to the remaining life rate. In FIG. 4, when the traveled distance of a candidate mobile object reaches Dc2, the second estimated remaining life β exceeds the first estimated remaining life α in length.

The candidate-mobile-object remaining-life recognition section 12 therefore recognizes the remaining life of the target part on the basis of the first estimated remaining life α in the period before Dc2 at which the second estimated remaining life β exceeds the first estimated remaining life α in length. In addition, the candidate-mobile-object remaining-life recognition section 12 recognizes the remaining life of the target part on the basis of the second estimated remaining life β in the period at or after Dc at which the second estimated remaining life β exceeds the first estimated remaining life α in length.

The remaining-life consumption degree recognition section 13 calculates the remaining-life consumption degrees of the respective target parts (the engine, the suspension, the electrical equipment, and the seat) for the user U to use the vehicle on the basis of load measurement information Lmi-001 and physical property value measurement information Pmi-001 for the period in which the user U used the old vehicle 50 that are illustrated in FIG. 3. The remaining-life consumption degrees each indicate the length of the remaining life of the target part predicted to be consumed (decreased) when the user U uses the vehicle for one year. The remaining-life consumption degree of each target part has the value obtained by dividing the years of the remaining life of the target part decreased in the period in which the user U used the old vehicle 50 by the years in which the user U used the old vehicle 50. The decreased years of the remaining life of each target part are calculated by subtracting the remaining life of each target part at the time point at which the user U changed the old vehicle 50 to another vehicle from the remaining life of each target part at the time point at which the user U started the use of the old vehicle 50. The remaining life of each target part is calculated through a process similar to the recognition of a remaining life by the candidate-mobile-object remaining-life recognition section 12 described above.

The mobile-object usage change estimation section 14 accesses the schedule DB 221 of the schedule server 220 to acquire the schedule information Sci and the profile information Upi about the user U. The mobile-object usage change estimation section 14 then estimates a change in the usage of the vehicle (such as changing the number of riding people or starting to drive smoothly) to be made after the user U changes the vehicle on the basis of a change in the lifestyle of the user U predicted from the schedule information Sci and the profile information Upi.

The remaining-life consumption degree recognition section 13 corrects the remaining-life consumption degree of each target part on the basis of the change in the usage of the vehicle by the user U estimated by the mobile-object usage change estimation section 14. The corrected-remaining-life calculation section 15 uses the corrected remaining-life consumption degree to calculate a corrected remaining life obtained by correcting the remaining life of each target part of each candidate vehicle recognized by the candidate-mobile-object remaining-life recognition section 12.

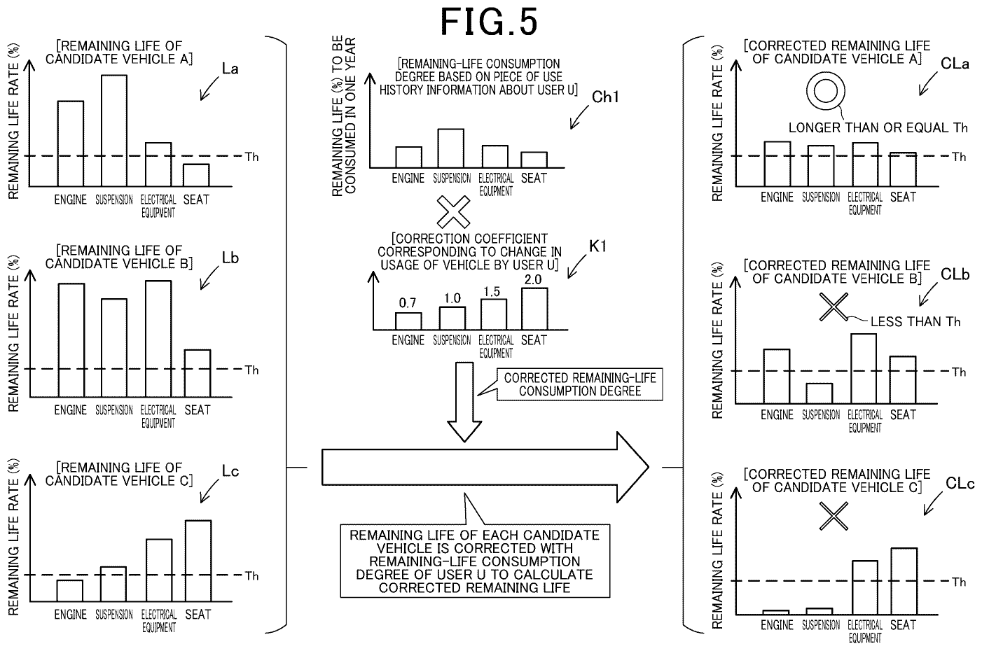

Here, FIG. 5 is an explanatory diagram of the series of processes by the candidate-mobile-object remaining-life recognition section 12, the remaining-life consumption degree recognition section 13, the mobile-object usage change estimation section 14, and the corrected-remaining-life calculation section 15. The candidate-mobile-object remaining-life recognition section 12 recognizes remaining lives La to Lc of the respective target parts (the engines, the suspensions, the pieces of electrical equipment, and the seats) of the candidate vehicles A to C as described above on the basis of pieces of load measurement information Lmi-002 to Lmi-004 and pieces of physical property value measurement information Pmi-002 to Pmi-004 about the respective target parts recorded in the vehicle management DB 211. Th in each of La to Lc denotes a determination remaining life corresponding to a desired-remaining-life condition of the user U.

The remaining-life consumption degree recognition section 13 recognizes a remaining-life consumption degree Ch1 of a target part of a vehicle by the user U as described above on the basis of the load measurement information Lmi-001 and the physical property value measurement information Pmi-001 about the old vehicle 50 recorded in the vehicle management DB 211. The mobile-object usage change estimation section 14 estimates a change in the usage of a vehicle to be made after the user U changes the vehicle on the basis of a change in the lifestyle of the user U predicted from the schedule information Sci and the profile information Upi about user U, and sets a correction coefficient K1 corresponding to a result of the estimation. K1 in FIG. 5 is set to increase the remaining-life consumption degrees of a suspension and a seat and decrease the remaining-life consumption degrees of an engine and electrical equipment.

The corrected-remaining-life calculation section 15 corrects the remaining lives La to Lc of the respective target parts of the candidate vehicles A to C by using the corrected remaining-life consumption degrees of the respective target parts to calculate corrected remaining lives CLa to CLc of the respective target parts of the candidate vehicles A to C. In FIG. 5, the corrected remaining life CLa of the candidate vehicle A among the corrected remaining lives CLa to CLc is longer than or equal to Th.

The transaction target mobile-object selection section 16 selects a candidate vehicle that meets a desired-remaining-life condition of the user U among the candidate vehicles A to C as a transaction target vehicle that is matched with the user U. In the example of FIG. 5, the transaction target mobile-object selection section 16 selects the candidate vehicle A as a transaction target vehicle.

### 2. Process of Calculating Corrected Remaining Life of Target Part

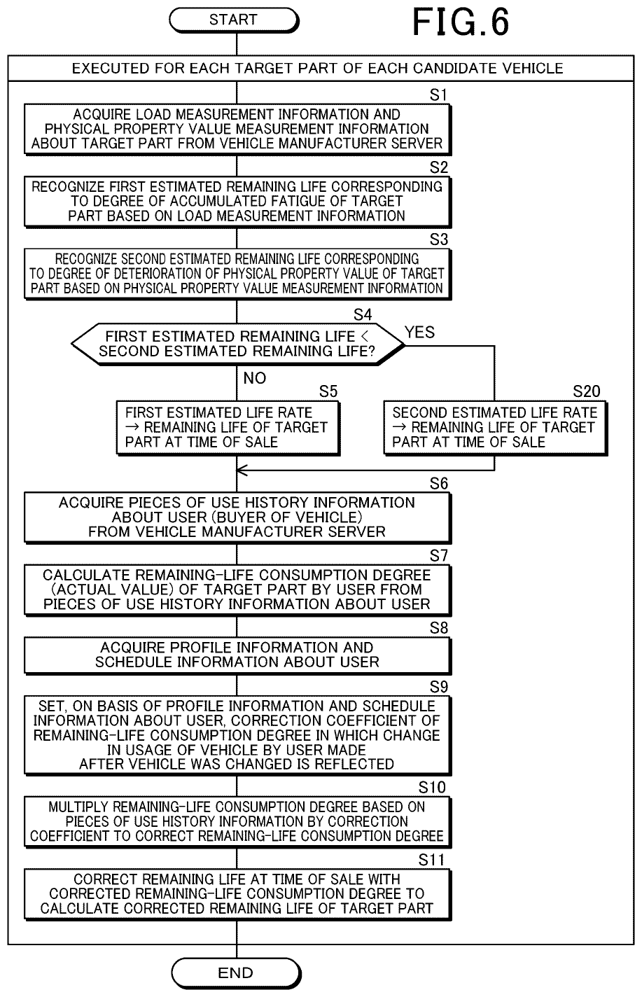

A procedure of a process of calculating the corrected remaining lives of the respective target parts of the candidate vehicles A to C that is executed by the mobile object brokerage system 1 will be described in accordance with the flowchart illustrated in FIG. 6. The mobile object brokerage system 1 executes the process corresponding to the flowchart illustrated in FIG. 6 for the respective target parts (the engines, the suspensions, the pieces of electrical equipment, and the seats) of the candidate vehicles A to C.

Steps S1 to S5 and S20 in FIG. 6 are processes by the candidate-mobile-object remaining-life recognition section 12. In step S1, the candidate-mobile-object remaining-life recognition section 12 accesses the vehicle management DB 211 of the vehicle manufacturer server 210 to acquire the load measurement information Lmi and the physical property value measurement information Pmi about a target part recorded in the vehicle management DB 211.

In subsequent step S2, the candidate-mobile-object remaining-life recognition section 12 recognizes the first estimated remaining life corresponding to the degree of accumulated fatigue of the target part based on the load measurement information Lmi. In next step S3, the candidate-mobile-object remaining-life recognition section 12 recognizes the second estimated remaining life corresponding to the deterioration degree of a physical property value of the target part based on the physical property value measurement information Pmi. In subsequent step S4, the candidate-mobile-object remaining-life recognition section 12 determines whether or not the second estimated remaining life is longer than the first estimated remaining life, and advances the process to step S20 when the second estimated remaining life is longer than the first estimated remaining life and advances the process to step S5 when the second estimated remaining life is less than or equal to the first estimated remaining life.

In step S5, the candidate-mobile-object remaining-life recognition section 12 sets the first estimated remaining life as the remaining life (the remaining life at the time of sale) of the target part. In step S20, the candidate-mobile-object remaining-life recognition section 12 sets the second estimated remaining life as the remaining life (the remaining life at the time of sale) of the target part and advances the process to step S6. Steps S6 to S7 are processes by the remaining-life consumption degree recognition section 13. In step S6, the remaining-life consumption degree recognition section 13 accesses the vehicle management DB 211 of the vehicle manufacturer server 210 to acquire the load measurement information Lmi and the physical property value measurement information Pmi (Lmi-003 and Pmi-003 in FIG. 3) about a target part of the old vehicle 50 that are pieces of use history information about the old vehicle 50 by the user U and were recorded when the user U used the old vehicle 50.

In next step S7, the remaining-life consumption degree recognition section 13 recognizes the remaining-life consumption degree (actual value) (see Ch1 in FIG. 5) of the target part for the user U to use the vehicle on the basis of the pieces of use history information about the old vehicle 50 by the user U. Subsequent steps S8 to S9 are processes by the mobile-object usage change estimation section 14. In step S8, the mobile-object usage change estimation section 14 accesses the schedule DB 221 of the schedule server 220 to acquire the schedule information Sci and the profile information Upi about the user U.

In next step S9, as described above, the mobile-object usage change estimation section 14 sets, on the basis of the schedule information Sci and the profile information Upi about the user U, a correction coefficient (see K1 in FIG. 5) of the remaining-life consumption degree in which a change in the usage of the vehicle by the user U to be made after the vehicle is changed is reflected.

Subsequent step S10 is a process by the remaining-life consumption degree recognition section 13. In step S10, the remaining-life consumption degree recognition section 13 multiplies the remaining-life consumption degree based on the pieces of use history information about the user U by the correction coefficient set by the mobile-object usage change estimation section 14 to correct the remaining-life consumption degree (see Ch1 and K1 of FIG. 5).

Subsequent step S11 is a process by the corrected-remaining-life calculation section 15. The corrected-remaining-life calculation section 15 corrects the remaining life (see any of La to Lc of FIG. 5) of the target part recognized by the candidate-mobile-object remaining-life recognition section 12 by using the corrected remaining-life consumption degree to calculate the corrected remaining life (see any of CLa to CLc of FIG. 5) of the target part. According to CLa to CLc of FIG. 5, the remaining lives of the suspensions serve as the remaining lives of the candidate vehicles A and B for the candidate vehicles A and B and the remaining life of the engine serves as the remaining life of the candidate vehicle C for the candidate vehicle C.

### 3. Process of Selecting Transaction Target Vehicle

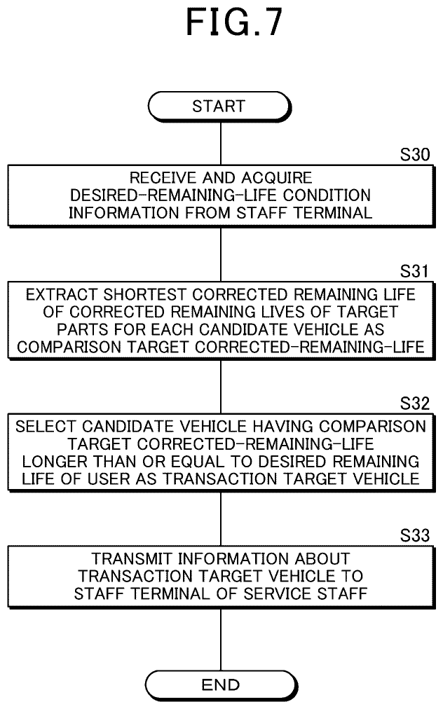

A process of selecting a transaction target vehicle that is executed by the mobile object brokerage system will be described in accordance with the flowchart illustrated in FIG. 7.

Step S30 in FIG. 7 is a process by the desired-remaining-life condition recognition section 11. The desired-remaining-life condition recognition section 11 receives and acquires the desired-remaining-life condition information Dci from the staff terminal 70 (see FIG. 1). Subsequent steps S31 to S33 are processes by the transaction target mobile-object selection section 16. In step S31, the transaction target mobile-object selection section 16 extracts the shortest corrected remaining life of the corrected remaining lives of the respective target parts calculated by the corrected-remaining-life calculation section 15 for each of the candidate vehicles A to C as a comparison target corrected-life. In the examples of CLa to CLc illustrated in FIG. 5, the corrected remaining lives of the suspensions are extracted as comparison target remaining-lives for the candidate vehicles A and B and the corrected remaining life of the engine is extracted as a comparison target remaining-life for the candidate vehicle C.

In next step S32, the transaction target mobile-object selection section 16 selects, as a transaction target vehicle, a candidate vehicle having a comparison target corrected-remaining-life longer than or equal to a desired remaining life of the user U that is indicated by the desired-remaining-life condition information Dci. In the illustrated example of FIG. 5, only the candidate vehicle A of the candidate vehicles A to C is selected as a transaction target vehicle.

It is to be noted that, when there is a plurality of candidate vehicles having comparison target corrected-remaining-lives each longer than or equal to a desired remaining life of the user U, the candidate mobile object having the smallest difference between the comparison target corrected-remaining-life and the desired remaining life of the user U may be selected as a transaction target vehicle. Since, as a candidate mobile object has a longer remaining life, the candidate mobile object is supposed to have a higher selling price, such selection makes it possible to match the user U with a transaction target vehicle having a lower cost.

In subsequent step S33, the transaction target mobile-object selection section 16 transmits transaction target vehicle information Qti regarding the transaction target vehicle to the staff terminal 70. It is possible for the service staff V to advance a business discussion with the user U while showing the user U the information about the transaction target vehicle displayed on the staff terminal 70.

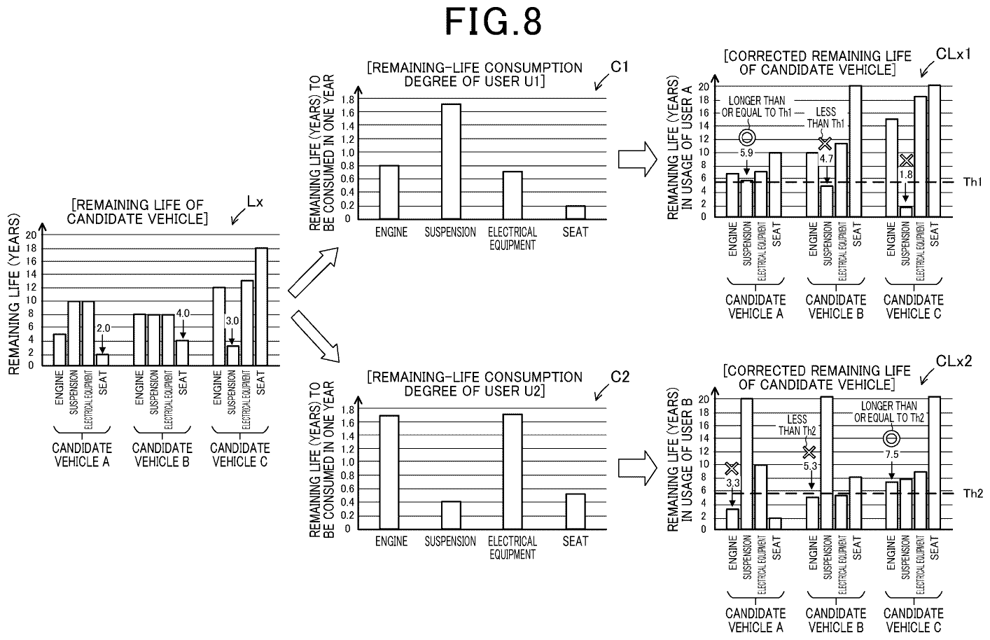

Here, FIG. 8 illustrates an example in which the corrected remaining life of one candidate vehicle is calculated for a plurality of users U1 and U2. In FIG. 8, a remaining life Lx of each of the target parts (the engines, the suspensions, the pieces of electrical equipment, and the seats) of the candidate vehicles A to C is divided by the remaining-life consumption degree of each of the target parts of the vehicle by user U1 to calculate a corrected remaining life CLx1 of each of the target parts of the candidate vehicles A to C for the user U1.

Similarly, the remaining life Lx of each of the target parts of the candidate vehicles A to C is divided by the remaining-life consumption rate of each of the target parts of the vehicle by user U2 to calculate a corrected remaining life CLx2 of each of the target parts of the candidate vehicles A to C for the user U2. In the example of FIG. 8, the candidate vehicle A having a corrected remaining life longer than or equal to a desired remaining life Th1 of the user U1 in CLx1 is selected as a transaction target vehicle for the user U1. In addition, the candidate vehicle C having a corrected remaining life longer than or equal to a desired remaining life Th2 of the user U2 in CLx2 is selected as a transaction target vehicle for the user U2.

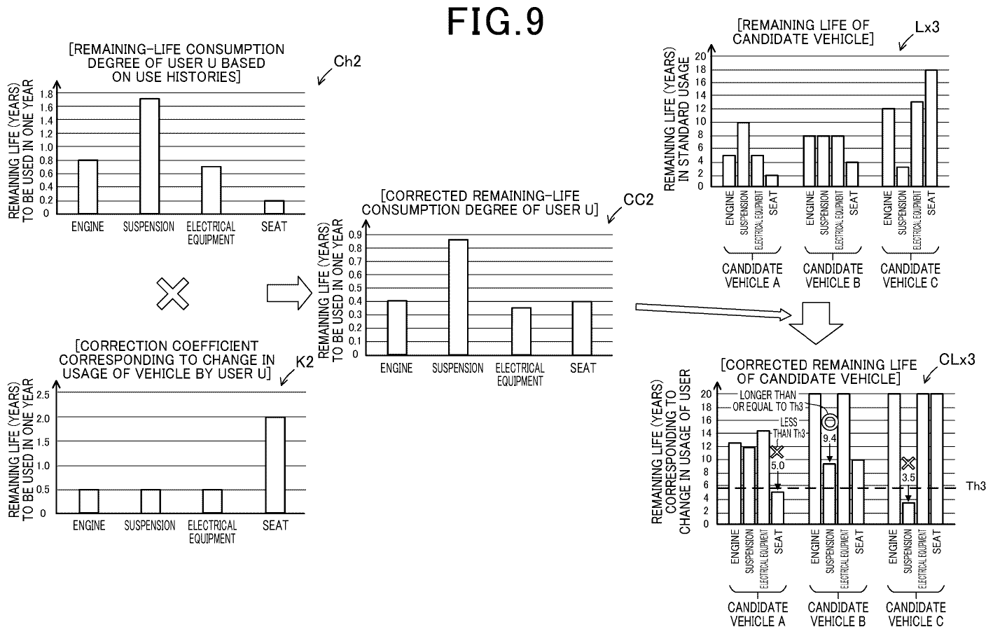

In addition, FIG. 9 illustrates an example in which the remaining-life consumption degree of the user U is corrected to calculate the corrected remaining lives of the candidate vehicles A to C. In FIG. 9, a remaining-life consumption degree Ch2 of a target part (the engine, the suspension, the electrical equipment, or the seat) of a vehicle by the user U that is based on use histories (the load measurement information Lmi-001 and the physical property value measurement information Pmi-001 in the period in which the old vehicle 50 was used; see FIG. 3) of the user U is corrected with a correction coefficient K2 corresponding to a change in the usage of a vehicle by the user U.

A remaining life Lx3 (the remaining life recognized by the candidate-mobile-object remaining-life recognition section 12) of each of the target parts of the respective candidate vehicles A to C in standard usage are then divided by a corrected remaining-life consumption degree CC2 of each of the target parts to calculate a corrected remaining life CLx3 of each of the target parts of the respective candidate vehicles A to C. The candidate vehicle B having a corrected remaining life longer than or equal to a desired remaining life Th3 of the user U in CLx3 is selected as a transaction target vehicle.

### 4. Other Embodiments

In the embodiment described above, an engine, a suspension, electrical equipment, and a seat have been exemplified as target parts whose remaining-life consumption degrees are predicted, but another part such as a battery whose remaining-life consumption degree changes in accordance with the usage of a vehicle may be adopted as a target part.

In the embodiment described above, a vehicle has been exemplified as the mobile object according to the present disclosure, but the mobile object according to the present disclosure may be an aircraft, a vessel, or the like.

In the embodiment described above, the mobile-object usage change estimation section 14 has been included and the remaining-life consumption degree recognition section 13 has corrected a remaining-life consumption degree in accordance with a change in the usage of a vehicle by the user U estimated by the mobile-object usage change estimation section 14, but a configuration may be adopted in which the mobile-object usage change estimation section 14 is omitted.

In the embodiment described above, remaining-life consumption degrees have been recognized for the four target parts (the engine, the suspension, the electrical equipment, and the seat) of a vehicle to calculate the corrected remaining lives of the target parts, but remaining-life consumption degrees may be predicted for three or less or five or more target parts to calculate the corrected remaining lives.

In the embodiment described above, the used candidate vehicles A to C have been described, but the candidate vehicles may be new cars. When the candidate vehicles are new cars, the candidate-mobile-object remaining-life recognition section 12 recognizes the standard remaining lives of the respective target parts corresponding to the vehicle types or models of the candidate vehicles as the remaining lives of the candidate vehicles at the time of sale.

In the embodiment described above, the mobile object brokerage system 1 has been described that communicates with the vehicle manufacturer server 210 and the staff terminal 70, but some or all of the components of the mobile object brokerage system 1 may include the store management system 101, the vehicle manufacturer server 210, the staff terminal 70, and the user terminal 71. When the mobile object brokerage system 1 is configured as part of a function of the vehicle manufacturer server 210, the transaction target vehicle information Qti is transmitted from the vehicle manufacturer server 210 to the staff terminal 70. When the mobile object brokerage system 1 is configured as part of a function of the store management system 101, the load measurement information Lmi is transmitted from the vehicle manufacturer server 210 to the store management system 101 and the transaction target vehicle information Qti is transmitted from the store management system 101 to the staff terminal 70.

It is to be noted that FIG. 1 is a schematic diagram in which the configuration of the mobile object brokerage system 1 is divided in accordance with the chief processing contents for facilitating the understandings of the invention of this application and the mobile object brokerage system 1 may be configured in accordance with other division. In addition, the process of each of the components may be executed by one hardware unit or executed by a plurality of hardware units. In addition, the process by each of the components illustrated in any of FIGS. 6 and 7 may be executed by one program or executed by a plurality of programs.

### 5. Configurations Supported by Embodiments Above

The embodiments described above are specific examples of the following configurations.

(Configuration 1) A mobile object brokerage system including: a desired-remaining-life condition recognition section configured to recognize a desired-remaining-life condition of a user for a mobile object, the user intending to start use of a mobile object through a predetermined transaction; a candidate-mobile-object remaining-life recognition section configured to recognize a remaining life of each of a plurality of candidate mobile objects that are candidates in the predetermined transaction; a remaining-life consumption degree recognition section configured to recognize a remaining-life consumption degree on the basis of use history information about a mobile object by the user, the remaining-life consumption degree being a consumption degree of a remaining life of a mobile object per predetermined period for the user to use the mobile object; a corrected-remaining-life calculation section configured to calculate a corrected remaining life obtained by correcting the remaining life of each of a plurality of the candidate mobile objects recognized by the candidate-mobile-object remaining-life recognition section with the remaining-life consumption degree; and a transaction target mobile-object selection section configured to select, as a target for the predetermined transaction with the user, the candidate mobile object having the corrected remaining life that meets the desired-remaining-life condition.

The mobile object brokerage system according to Configuration 1 makes it possible to match a user who intends to start the use of a mobile object such as a vehicle through a transaction with a mobile object which meets a desired-remaining-life condition of the user.

(Configuration 2) The mobile object brokerage system according to Configuration 1, including a mobile-object usage change estimation section configured to estimate a change in usage of a mobile object by the user, the change being to be made after the user starts the use of the mobile object in the predetermined transaction, in which the remaining-life consumption degree recognition section recognizes the remaining-life consumption degree by correcting the consumption degree of the remaining life of the mobile object per predetermined period for the user to use the mobile object in accordance with the change in the usage of the mobile object by the user, the consumption degree being based on the use history information, the change being estimated by the mobile-object usage change estimation section.

The mobile object brokerage system according to Configuration 2 makes it possible to select a mobile object that meets the desired-remaining-life condition of the user more by reflecting the change in the usage of the mobile object by the user to recognize the remaining-life consumption degree of the mobile object by the user.

(Configuration 3) The mobile object brokerage system according to Configuration 2, in which the mobile-object usage change estimation section estimates the change in the usage of the mobile object by the user on the basis of profile information about the user or schedule information about the user, the change being to be made after the user starts the use of the mobile object in the predetermined transaction.

The mobile object brokerage system according to Configuration 3 makes it possible to estimate the change in the usage of the mobile object by the user on the basis of the age, the living environment, or the like of the user recognized from the profile information or a change of address, a change of the family structure, or the like of the user grasped from the schedule information.

(Configuration 4) The mobile object brokerage system according to any one of Configurations 1 to 3, in which the transaction target mobile-object selection section selects, as the candidate mobile object having the corrected remaining life that meets the desired-remaining-life condition, the candidate mobile object having a difference of a predetermined value or less between the corrected remaining life and a desired life corresponding to the desired-remaining-life condition.

The mobile object brokerage system according to Configuration 4 makes it possible to broker a candidate mobile object having a lower cost for the user because a candidate mobile object having an excessive remaining life is excluded from selection targets by selecting a candidate mobile object having a remaining life close to the desired life corresponding to the desired-remaining-life condition.

(Configuration 5) The mobile object brokerage system according to any one of Configurations 1 to 4, in which the candidate-mobile-object remaining-life recognition section recognizes a remaining life for each of a plurality of target parts included in the candidate mobile object, the remaining-life consumption degree recognition section recognizes the remaining-life consumption degree for each of a plurality of the target parts, the corrected-remaining-life calculation section calculates the corrected remaining life for each of a plurality of the target parts, and the transaction target mobile-object selection section determines for each of a plurality of the target parts whether or not the corrected remaining life meets the desired-remaining-life condition, and selects the candidate mobile object that meets the desired-remaining-life condition.

According to the mobile object brokerage system according to Configuration 5, the remaining lives of the plurality of target parts vary in accordance with the usage of the mobile object by the user. This makes it possible to select a candidate mobile object that is compatible with the usage of the user by calculating the corrected remaining lives for the plurality of target parts and determining for each of the plurality of target parts whether or not the corrected remaining life meets the desired-remaining-life condition.

(Configuration 6) A mobile object brokerage method that is executed by a computer to mediate between a user who wishes to use a mobile object and a provider of the mobile object, the mobile object brokerage method including: a desired-remaining-life condition recognition step of recognizing a desired-remaining-life condition of a user for a mobile object, the user intending to start use of a mobile object through a predetermined transaction; a candidate-mobile-object remaining-life recognition step of recognizing a remaining life of each of a plurality of candidate mobile objects that are candidates in the predetermined transaction; a remaining-life consumption degree recognition step of recognizing a remaining-life consumption degree on the basis of use history information about a mobile object by the user, the remaining-life consumption degree being a consumption degree of a remaining life of a mobile object per predetermined period for the user to use the mobile object; a corrected-remaining-life calculation step of calculating a corrected remaining life obtained by correcting the remaining life of each of a plurality of the candidate mobile objects recognized by the candidate-mobile-object remaining-life recognition step with the remaining-life consumption degree; and a transaction target mobile-object selection step of selecting, as a target for the predetermined transaction with the user, the candidate mobile object having the corrected remaining life that meets the desired-remaining-life condition.

The execution of the mobile object brokerage method according to Configuration 6 by the computer makes it possible to obtain the workings and effects similar to those of the mobile object brokerage system according to Configuration 1.

### REFERENCE SIGNS LIST

1 mobile object brokerage system
10 processor
11 desired-remaining-life condition recognition section
12 candidate-mobile-object remaining-life recognition section
13 remaining-life consumption degree recognition section
14 mobile-object usage change estimation section
15 corrected-remaining-life calculation section
16 transaction target mobile-object selection section
20 memory
21 program
22 data of load-to-degree-of-fatigue map
23 data of physical-property-value-deterioration-degree-to-remaining-life map
30 communication unit
50 vehicle (mobile object)
51 ECU
52 sensors
70 staff terminal
71 user terminal
100 car dealer
101 store management system
200 communication network
210 vehicle manufacturer server
211 vehicle management DB
220 schedule server
221 schedule DB
U user
V service staff (of car dealer)

What is claimed is:

1. A mobile object brokerage system comprising:
a desired-remaining-life condition recognition section configured to recognize a desired-remaining-life condition of a user for a mobile object, the user intending to start use of a mobile object through a predetermined transaction;
a candidate-mobile-object remaining-life recognition section configured to recognize a remaining life of each of a plurality of candidate mobile objects that are candidates in the predetermined transaction;
a remaining-life consumption degree recognition section configured to recognize a remaining-life consumption degree on a basis of use history information about a mobile object by the user, the remaining-life consumption degree being a consumption degree of a remaining life of a mobile object per predetermined period for the user to use the mobile object;
a corrected-remaining-life calculation section configured to calculate a corrected remaining life obtained by correcting the remaining life of each of a plurality of the candidate mobile objects recognized by the candidate-mobile-object remaining-life recognition section with the remaining-life consumption degree; and
a transaction target mobile-object selection section configured to select, as a target for the predetermined transaction with the user, the candidate mobile object having the corrected remaining life that meets the desired-remaining-life condition.

2. The mobile object brokerage system according to claim 1, comprising a mobile-object usage change estimation section configured to estimate a change in usage of a mobile object by the user, the change being to be made after the user starts the use of the mobile object in the predetermined transaction, wherein
the remaining-life consumption degree recognition section recognizes the remaining-life consumption degree by correcting the consumption degree of the remaining life of the mobile object per predetermined period for the user to use the mobile object in accordance with the change in the usage of the mobile object by the user, the consumption degree being based on the use history information, the change being estimated by the mobile-object usage change estimation section.

3. The mobile object brokerage system according to claim 2, wherein the mobile-object usage change estimation section estimates the change in the usage of the mobile object by the user on a basis of profile information about the user or schedule information about the user, the change being to be made after the user starts the use of the mobile object in the predetermined transaction.

4. The mobile object brokerage system according to claim 1, wherein the transaction target mobile-object selection section selects, as the candidate mobile object having the corrected remaining life that meets the desired-remaining-life condition, the candidate mobile object having a difference of a predetermined value or less between the corrected remaining life and a desired life corresponding to the desired-remaining-life condition.

5. The mobile object brokerage system according to claim 1, wherein
the candidate-mobile-object remaining-life recognition section recognizes a remaining life for each of a plurality of target parts included in the candidate mobile object,
the remaining-life consumption degree recognition section recognizes the remaining-life consumption degree for each of a plurality of the target parts,
the corrected-remaining-life calculation section calculates the corrected remaining life for each of a plurality of the target parts, and
the transaction target mobile-object selection section determines for each of a plurality of the target parts whether or not the corrected remaining life meets the desired-remaining-life condition, and selects the candidate mobile object that meets the desired-remaining-life condition.

6. A mobile object brokerage method that is executed by a computer to mediate between a user who wishes to use a mobile object and a provider of the mobile object, the mobile object brokerage method comprising:
a desired-remaining-life condition recognition step of recognizing a desired-remaining-life condition of a user for a mobile object, the user intending to start use of a mobile object through a predetermined transaction;
a candidate-mobile-object remaining-life recognition step of recognizing a remaining life of each of a plurality of candidate mobile objects that are candidates in the predetermined transaction;
a remaining-life consumption degree recognition step of recognizing a remaining-life consumption degree on a basis of use history information about a mobile object by the user, the remaining-life consumption degree being a consumption degree of a remaining life of a mobile object per predetermined period for the user to use the mobile object;
a corrected-remaining-life calculation step of calculating a corrected remaining life obtained by correcting the remaining life of each of a plurality of the candidate mobile objects recognized by the candidate-mobile-object remaining-life recognition step with the remaining-life consumption degree; and
a transaction target mobile-object selection step of selecting, as a target for the predetermined transaction with the user, the candidate mobile object having the corrected remaining life that meets the desired-remaining-life condition.
